(19) United States
(12) Patent Application Publication
(10) Pub. No.: US 2016/0197405 A1
(43) Pub. Date: Jul. 7, 2016

(54) ARRAY ANTENNA DEVICE

(71) Applicant: KABUSHIKI KAISHA TOSHIBA, Tokyo (JP)

(72) Inventors: Makoto HIGAKI, Setagaya Tokyo (JP); Koh HASHIMOTO, Yokohama Kanagawa (JP); Manabu MUKAI, Yokohama Kanagawa (JP)

(73) Assignee: KABUSHIKI KAISHA TOSHIBA, Tokyo (JP)

(21) Appl. No.: 14/924,512

(22) Filed: Oct. 27, 2015

(30) Foreign Application Priority Data
Jan. 5, 2015 (JP) 2015-000478

(51) Int. Cl. H01Q 9/04; H01Q 1/50

(52) U.S. Cl. CPC H01Q 9/045; H01Q 1/50

(57) ABSTRACT

An array antenna device includes a plurality of radiating elements, a plurality of radiating elements and a plurality of feeder paths. The plurality of radiating elements are disposed in a plurality of regions defined by excluding at least one region of at least one of the four corners of a polygon defined by overall 2^{N}×2^{N} regions, from the 2^{N}×2^{N} regions provided in a two-dimensional matrix arrangement, where N is an arbitrary natural number of 2 or greater. The plurality of feeder paths feed the plurality of radiating elements.

### CROSS REFERENCE TO RELATED APPLICATION

This application is based upon and claims the benefit of priority from Japanese Patent Application No. 2015-000478, filed Jan. 5, 2015, the entire contents of which are incorporated herein by reference.

### FIELD

Embodiments described herein relate generally to an array antenna device.

### BACKGROUND

An array antenna device in which a plurality of radiating elements are disposed in a two-dimensional matrix has been conventionally known. In this array antenna device, if the number of radiating elements increases, the aperture area of the antenna increases. However, it might not have been possible to improve the antenna performance with respect to the maximum diameter of a circle externally tangent to a given antenna aperture area with only an increase in the antenna aperture area accompanying an increase in the number of radiating elements.

### BRIEF DESCRIPTION OF THE DRAWINGS

FIG. 1 is an oblique view showing, in schematic form, an array antenna device of an embodiment.

FIG. 2 is a plan view showing the disposition of a plurality of radiating elements in an array antenna device of an embodiment.

FIG. 3 is a plan view showing the minimum diameter of a circle that includes a plurality of radiating elements of an array antenna device of an embodiment and the minimum diameter of a circle that includes radiating elements disposed in an entire region of 2^{N}×2^{N} thereof of an array antenna device of an embodiment.

FIG. 4 is a plan view showing the disposition of a plurality of the radiating elements an array antenna device of a variation example of an embodiment.

FIG. 5 is an oblique view showing, in schematic form, the constitution of an array antenna device of a first variation example of an embodiment.

FIG. 6 is an oblique view showing, in schematic form, the constitution of an array antenna device of a second variation example of an embodiment.

FIG. 7 is an oblique view showing, in schematic form, the constitution of an array antenna device of a third variation example of an embodiment.

FIG. 8 is a diagram illustrating an array of radiating elements and a feeder path system connecting the radiating elements in some embodiments.

FIG. 9 is a plan view showing the formula M.

### DETAILED DESCRIPTION

In some embodiments, an array antenna device includes a plurality of radiating elements, a plurality of radiating elements and a plurality of feeder paths. The plurality of radiating elements are disposed in a plurality of regions defined by excluding at least one region of at least one of the four corners of a polygon defined by overall 2^{N}×2^{N} regions, from the 2^{N}×2^{N} regions provided in a two-dimensional matrix arrangement, where N is an arbitrary natural number of 2 or greater. The plurality of feeder paths feed the plurality of radiating elements.

In some cases, the at least one region in each of the four corners may be (((2^{N}/4) ×(1+2^{N}/4))/2) regions.

In some cases, the at least one region in each of the four corners are regions, at least one of which is included in a triangular shape defined by a vertex of the polygon and parts of the two sides connected to the vertex, and the polygon is a rectangle, and one of the two sides has ¼ of the length of a long side of the rectangle and the other of the two sides has ¼ of the length of a short side of the rectangle.

In some cases, the device may further include a resistive load disposed in the at least one region of the at least one of the four corners, wherein the feeder path is connected to the resistive load.

In some cases, the feeder paths include a first feeder path and a second feeder path. The first feeder path is connected to a first radiating element included in the plurality of radiating elements. The second feeder path is connected to a second radiating element included in the plurality of radiating elements. The second radiating element is closest to the first radiating element among the plurality of radiating elements. The first feeder path is closest to the at least one region of the at least one of the four corners among the feeder paths. The first feeder path is wider than the second feeder path.

In some cases, the device may further include a wireless communicator disposed in the at least one region of the at least one of the four corners, wherein a feeder path included in the plurality of feeder paths is connected to the wireless communicator.

In other embodiments, an array antenna device may include, but is not limited to, a plurality of radiating elements, and a plurality of feeder paths. The plurality of radiating elements are disposed in a two dimensional array of regions. The two dimensional array are in a polygonal region having a plurality of corners. The two dimensional array have an outer boundary. The outer boundary is in contact with the outer line of the polygonal region, except for at least one of the plurality of corners. The plurality of feeder paths feed the plurality of radiating elements.

In some cases, the polygonal region is a squire region. The two dimensional array is a modified 2^{N}×2^{N} array, where N is 2 or more natural number, wherein the modified 2^{N}×2^{N} array is obtained by excluding at least one radiating element which is closest to one of the four corners of the squire region, from 2^{N}×2^{N} array of the radiating elements.

In some cases, the at least one region in each of the four corners is (((2^{N}/4)×(1+2^{N}/4))/2) regions.

In some cases, the at least one region in each of the four corners are regions, at least one of which is included in a triangular shape defined by a vertex of the polygon and parts of the two sides connected to the vertex. The polygon is a rectangle, and one of the two sides has ¼ of the length of a long side of the rectangle and the other of the two sides has ¼ of the length of a short side of the rectangle.

In some cases, the device may further include: a resistive load disposed in the at least one region of the at least one of the four corners, wherein the feeder path is connected to the resistive load.

In some cases, the feeder paths includes a first feeder path and a second feeder path, the first feeder path is connected to a first radiating element included in the plurality of radiating elements. The second feeder path is connected to a second radiating element included in the plurality of radiating elements, the second radiating element is closest to the first radiating element among the plurality of radiating elements. The first feeder path is closest to the at least one region of the at least one of the four corners among the feeder paths, and the first feeder path is wider than the second feeder path.

In some cases, the device may further include a wireless communicator disposed in the at least one region of the at least one of the four corners, wherein a feeder path included in the plurality of feeder paths is connected to the wireless communicator.

In other embodiments, an array antenna device may include, but is not limited to, a plurality of pairs of first and second radiating elements, a feeder path system comprising a main feeder path and a plurality of local feeder paths, the main feeder path being connected to the plurality of local feeder paths; each of the plurality of local feeder paths connecting the first and second radiating element in a pair; and a third radiating element connected to the feeder path system.

In some cases, the third radiating element is closest to at least one of the four corners of a polygonal region in which the plurality of pairs of first and second radiating elements, the feeder path system and the third radiating element are arrayed.

In some cases, the first, second and third radiating elements have substantially the same feed-path-length of the feeder path system each other.

In some cases, the first, second and third radiating elements have substantially the same feed-path-length of the feeder path system each other.

Various embodiments of the array antenna device will be described herein after with reference to the accompanying drawings.

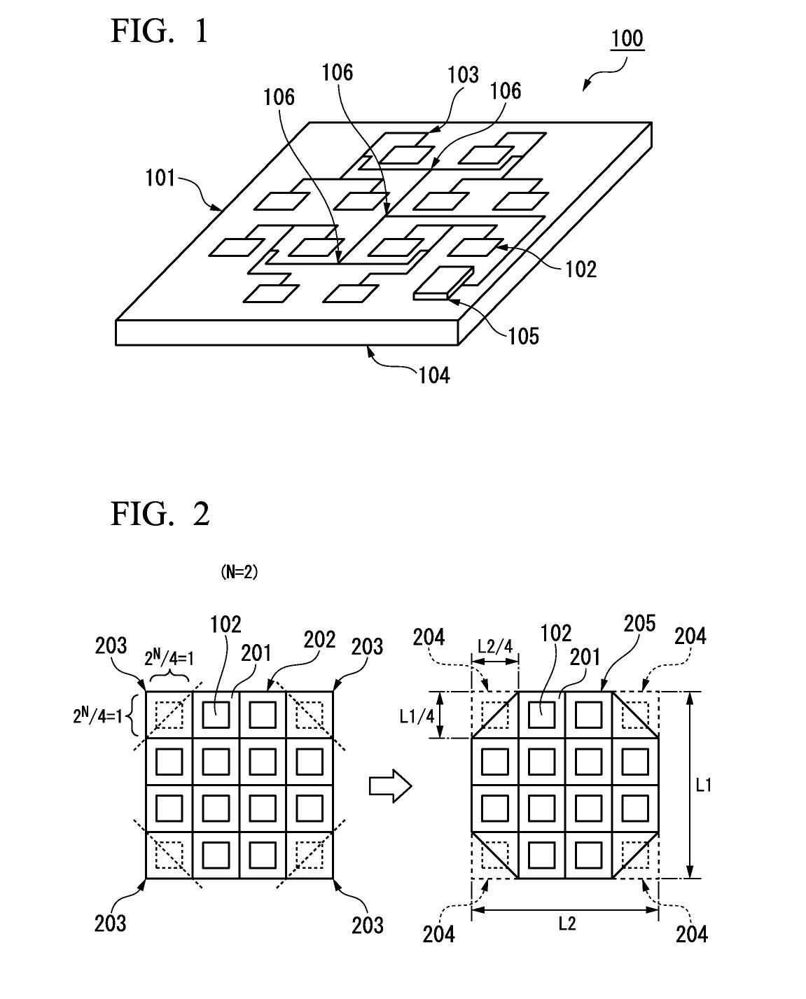

An array antenna device 100 of the embodiment, as shown in FIG. 1, has a dielectric substrate 101, a plurality of radiating elements 102, a feeder path 103, a ground conductor 104, and a wireless communicator 105.

The dielectric substrate 101 is an insulator, such as a resin substrate, a ceramic substrate, a foamed plastic, or a film substrate. The outer shape of the dielectric substrate 101 is a rectangle, for example, a square sheet.

Each of the plurality of radiating elements 102 is, for example, a metal patch. Each of the plurality of radiating elements 102 is formed, for example, by patterning an electrically conductive material onto a first main surface of the dielectric substrate 101. The outer shape of each radiating element 102 is a rectangle, for example, a square.

The plurality of radiating elements 102 are disposed in a matrix arrangement on the first main surface of the dielectric substrate 101.

The plurality of radiating elements 102, on the first main surface of the dielectric substrate 101, are disposed in prescribed regions of regions 201 provided in a two-dimensional matrix arrangement of 2^{N}×2^{N}, where N is an arbitrary natural number of 2 or greater. The prescribed regions have a plurality of regions 201 obtained by excluding at least one region 201 at each of four corner parts 203 of the square region 202 formed by the overall 2^{N}×2^{N} regions 201. The number of the at least one region 201 in a corner part 203 of the square region 202 is the prescribed number given by the formula M (where M=(((2^{N}/4)×(1+2^{N}/4))/2)) close to each of the vertices of the square region 202. The prescribed number M is the sum of an integer series, the first element of which is 1 and which has uniform spacing difference of 1 (1, 2, . . . , 2^{N}/4). If N=2, there are 12 regions 201, obtained by excluding the one region 201 closest to the vertices of the square region 202 at the four corner parts 203, as shown in FIG. 2.

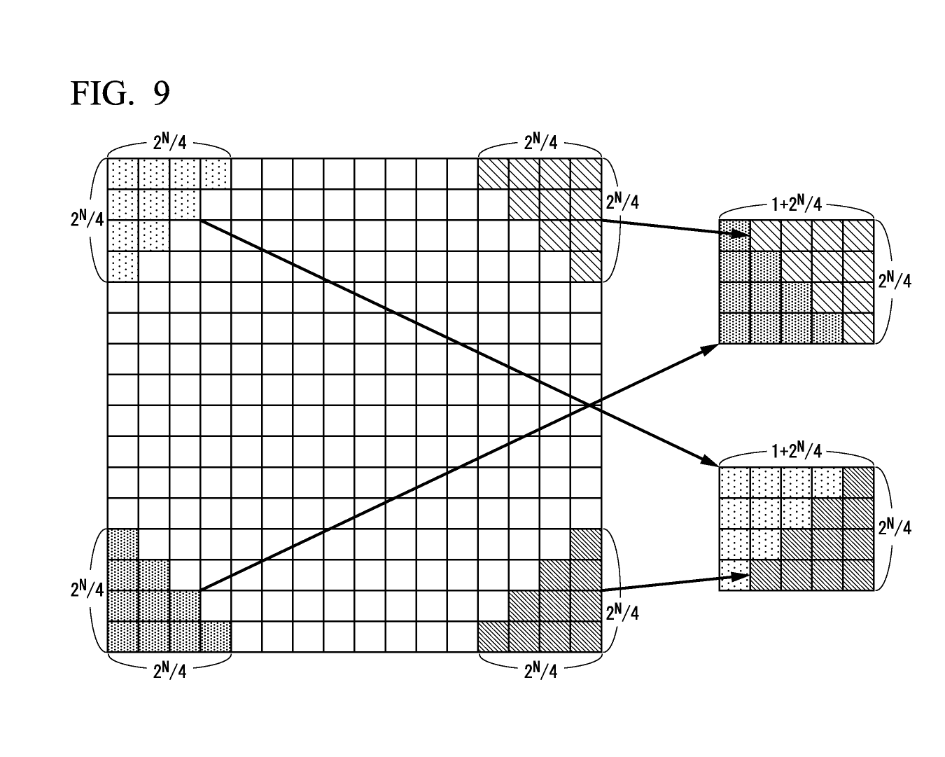

The reason that the number of the at least one region 201 is given by the above-described formula will be described with reference to FIG. 9, wherein N is the natural number equal to or greater than 2. In the each corner part 203, the regions 201 on which any elements are not disposed are marked with shade such as hatching. The corner part 203 is defined by an area in which any elements are not disposed on the regions 201. For example, the corner part 203 has two straight sides with a length of 2^{N}/4, and a stepped line connecting between the ends of the two straight sides. Assuming that the corner parts 203 at diagonally opposite corners are combined, then a rectangular area defined by (2^{N}/4) and (1+2^{N}/4) is given by the pair of the corner parts 203. The number of the regions 201 in the rectangular area is given by (2^{N}/4)×(1+2^{N}/4). The number of the at least one region 201 in each corner part 203 is a half of the number of the regions 201 in the rectangular area. Thus, the number of the at least one region 201 in each corner part 203 is given by ((2^{N}/4)×(1+2^{N}/4))/2). If N=4, the rectangular area is defined by (2⁴/4)×(1+2⁴/4) or by 4×5. The number of the regions 201 in the rectangular area is given by 20. Thus, the number of the region 201 in each corner part 203 in which any elements are not disposed is given by 10.

With reference back to FIG, 2, the prescribed regions have a plurality of regions 201 included in an octagonal region 205 obtained by excluding from the square region 202 triangular regions 204 that include the vertices in each of the four corner regions 203 of the square region 202. The triangular regions 204 are formed by the vertices of the square region 202 and a part of the two side connected to the vertices in each of the four corner parts 203 of the square region 202. The triangular regions 204 have a long side of the square region 202, having the length L1, and two sides connected to each vertex, having the length (L1/4) and the length (L2/4) with respect to the short side length L2.

The surface area of each triangular region 204 is 1/32 of the overall surface area of the square region 202.

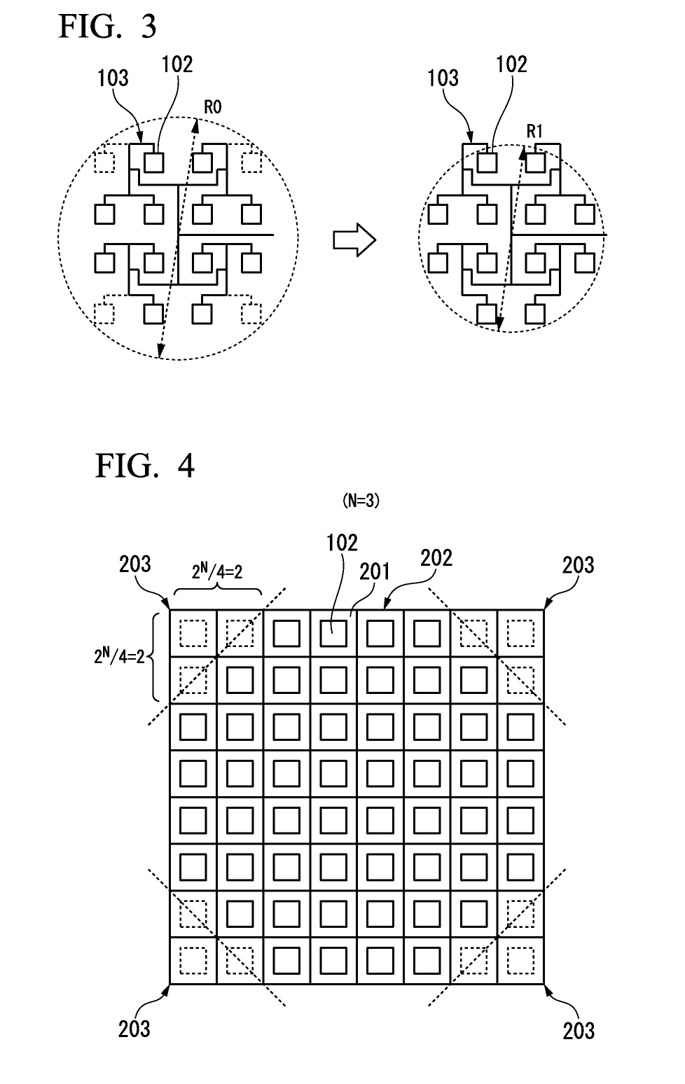

The diameter R1 of the smallest circle that includes all of the plurality of radiating elements 102 is smaller than the radius R0 of the circle that includes the radiating elements 102 disposed over the entire 2^{N}×2^{N} region 201, as shown in FIG. 3. The proportion of the surface area of the plurality of radiating elements that fill within the circle of diameter R1 is smaller than the proportion of the surface area of the 2^{N}×2^{N} radiating elements that fill the circle of radius R0.

The shape of the feeder path 103 is formed as a parallel feed type feeder path having a symmetrical structure that is a so-called complete tournament pyramid, with part thereof removed. The shape of the feeder path 103 is formed by removing from a parallel feed type feeder path having a symmetrical structure with respect to the 2^{N}×2^{N} regions 201 a feeder path with respect to regions 201, at least a part of which are included in each of the triangular regions 204.

The feeder path 103, similar to the plurality of radiating element 102, is formed by, for example, patterning an electrically conductive material onto the first main surface of the dielectric substrate 101. The feeder path 103 is, for example, a microstrip path. The ground conductor 104 is provided so as to cover a second main surface (that is, the surface on the opposite side from the first main surface) of the dielectric substrate 101.

The feeder path 103 is branched from one end connected to the wireless communicator 105 so that power can be distributed to all the radiating elements 102. The feeder path 103 has a plurality of T-shaped branching parts 106 connected in multiple levels.

The wireless communicator 105, at any one of the four corner parts 203 of the square region 204, is disposed in at least one region 201, at least one part of which is included in a triangular region 204. The wireless communicator 105 is mounted onto the same plane as the plurality of radiating elements 102. The wireless communicator 105 transmits and receives wireless signals with respect to the plurality of radiating elements 102.

According to the above-described embodiment, by having radiating elements 102 in a plurality of regions 201 obtained by excluding at least one region 201 from each corner part 203 of the 2^{N}×2^{N} regions 201, it is possible to reduce the antenna aperture area while suppressing a decrease in the antenna performance. By having radiating elements 102 that reduce the antenna aperture area while suppressing the number thereof that are removed from the 2^{N}×2^{N} regions, it is possible to improve the antenna performance per unit of surface area of the antenna aperture area.

Additionally, by having a wireless communicator 105 disposed in a region 201 which is excluded from the 2^{N}×2^{N} regions 201, it is possible to achieve a compact overall size for the array antenna device 100, including the wireless communicator 105.

Variation examples will be described below.

Although the above-described embodiment had a wireless communicator 105, this is not a restriction, and a device other than the wireless communicator 105 that transmits and receives high-frequency signals or a device that has a function other than a wireless function, such as a device that displays the operating state, may be mounted.

Although in the above-described embodiment the plurality of radiating elements 102 and the feeder path 103 were patterned onto the first main surface of the dielectric substrate 101, onto which is affixed a conductive film made of an electrically conductive material such as copper, by etching the first main surface, this is not a restriction.

A metal sheet having the patterns of the plurality of radiating elements 102 and the feeder path 103 may be laminated or affixed to the first main surface of the dielectric substrate 101.

The outer shape of each radiating element 102 may be, for example, a polygonal shape, a circular shape, or another complex shape.

Although, in the above-described embodiment, the plurality of radiating elements 102 and the feeder path 103 are disposed on the same plane and are electrically-connected, this is not a restriction. By increasing the metal layers that are laminated, a feeder scheme other than common-plane feed may be used.

The plurality of radiating elements 102 and the feeder path 103 may do proximity coupled feed by electromagnetic coupling, slot coupled feed that does electromagnetic feed via a slot, or rear-surface coupled feed by connection through a metal via.

Although in the above-described embodiment the radiating elements 102 were metal patches, this is not a restriction.

The radiating elements 102, for example, may be slot antennas or linear antennas.

Although the above-described embodiment took the value of N to be 2, any arbitrary natural number of 2 or greater may be used.

For example, in the case in which N is 3, as shown in FIG. 4, the radiating elements 102 are disposed in the 52 regions 201 that are obtained by excluding the three regions 201 that are the closest to each of the vertices in the four corner parts 203 of the square region 202 formed by all of the 2^{N}×2^{N} regions 201.

A first variation example will be described below.

In the above-described embodiment, the feeder path 103 may be connected to resistive loads 501 disposed in regions 201, at least a part of which is included in the regions 201 excluded from the 2^{N}×2^{N} regions 201, that is, in the triangular regions 204.

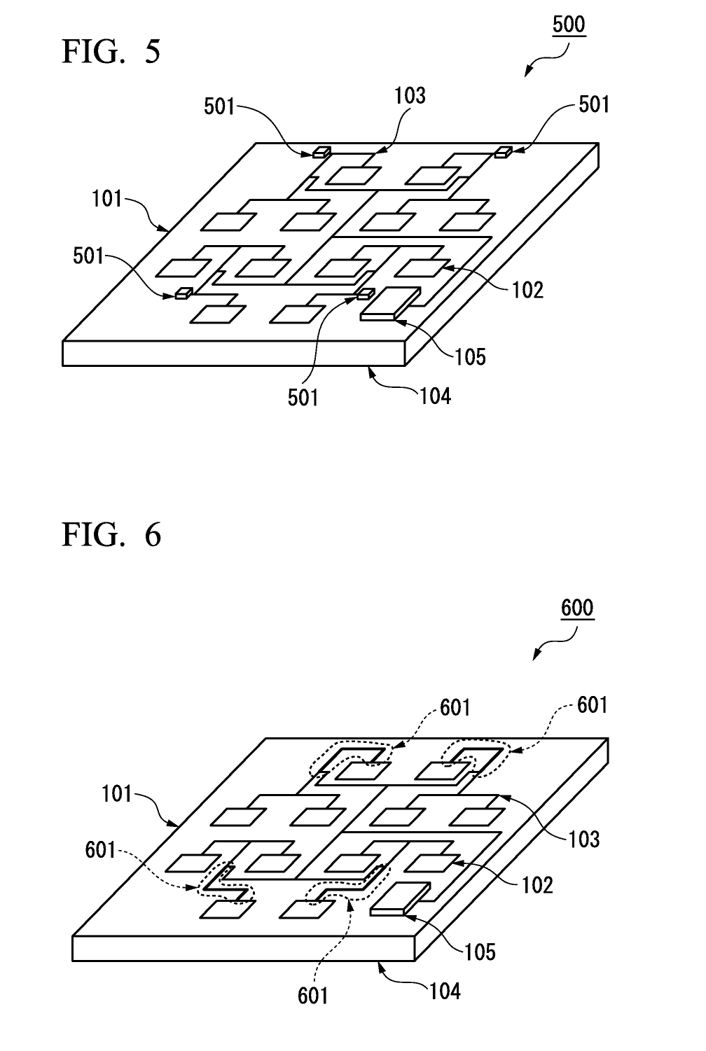

The array antenna device 500 of the first variation example, as shown in FIG. 5, has a dielectric substrate 101, a plurality of radiating elements 102, a feeder path 103, a ground conductor 104, a wireless communicator 105, and a plurality of resistive loads 501.

The plurality of resistive loads 501 are disposed in regions 201 excluded from the 2^{N}×2^{N} regions 201, that is, in the regions 201, at least a part of which is included in the triangular regions 204. Each of the plurality of resistive loads 501 has an impedance that is the same as the characteristic impedance of the feeder path 103.

According to the first variation example, by having resistive loads 501 with the same impedance as the characteristic impedance of the feeder path 103, it is possible to prevent the reflection of wireless signals from regions 201 in which radiating elements 102 do not exist. This enables the achievement of the same electromagnetic field distribution as the case in which, for example, radiating elements 102 are disposed at all of the 2^{N}×2^{N} regions 201.

The electromagnetic field distribution radiated from the overall array antenna device 500 is not disturbed, relative to the case in which, for example, radiating elements 102 are disposed at all of the 2^{N}×2^{N} regions 201, and is the same as in the case in which there is simply no electromagnetic field distribution at regions 201 that are excluded. This facilitates the achievement of the desired antenna performance.

The second variation example will be described below.

In the above-described embodiment, the shape of the feeder path 103 is made by removing from a parallel feed type feeder path having a symmetrical structure with respect to the 2^{N}×2^{N} regions 201 the feeder path with respect to regions 201, at least a part of which are included in the triangular regions 204.

The shape of the feeder path 103 may be formed so that locations 601 connected to radiating elements 102 disposed at regions 201 that form pairs with regions 201 that are excluded from the 2^{N}×2^{N} regions 201 are thicker than locations connected to other radiating elements 102.

In the array antenna device 600 of the second variation example, as shown in FIG. 6, locations 601 connected to radiating elements 102 in regions 201, at least a part of which are included in the triangular regions 204 are provided with a feeder path that is thicker than locations connected to other radiating elements 102. The locations 601 are connected to radiating elements 102 in regions 201, at least a part of which form pairs with regions 201, at least a part of which is included in the triangular regions 204, are included in the triangular regions 204, and to T-shaped branch parts 106 in direct proximity to those radiating elements 102. The thickness in the locations 601 is, for example, a thickness that enables supply of an amount of power of the radiating elements 102 that are omitted from the regions 201, at least a part of which are included in the triangular regions 204, added to the amount of power of the radiating elements 102 connected to locations 601.

According to the second variation example, by having a feeder path 103 having locations 601 connected to radiating elements 102 in regions 201 that form pairs with regions 201 that are excluded from the 2^{N}×2^{N} regions 201 that are thicker than those connected to other locations, it is possible to reduce the power loss in transmitting and receiving wireless signals. The power of radiating elements 102 omitted with respect to regions 201, at least a part of which are included in the triangular regions 204, can be supplied to radiating elements 102 of regions 201 forming pairs with regions 201, at least a part of which are included in the triangular elements.

The third variation example will be described below.

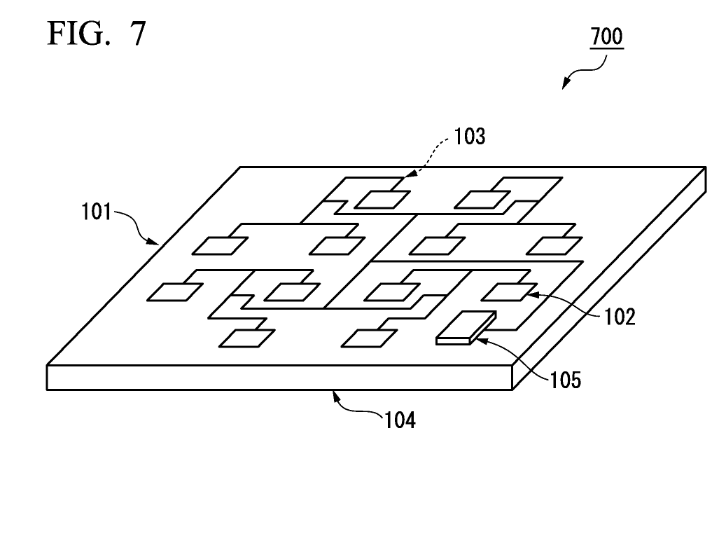

Although the outer shape of the dielectric substrate 101 was made a square sheet in the above-described embodiment, this is not a restriction and, as shown in the array antenna device 700 of the third variation example shown in FIG. 7, the outer shape of the dielectric substrate 101 may be made a rectangular shape.

According to at least one of the above-described embodiments, by having radiating elements 102 disposed at a plurality of regions 201 obtained by excluding at least one region 201 from the corner parts 203 of the 2^{N}×2^{N} regions 201, it is possible to reduce the antenna aperture area. By having radiating elements 102 that make the antenna aperture area small while suppressing the number of exclusions from the 2^{N}×2^{N}, it is possible to improve the antenna performance per unit of area of the antenna aperture area while suppressing reduction of antenna performance.

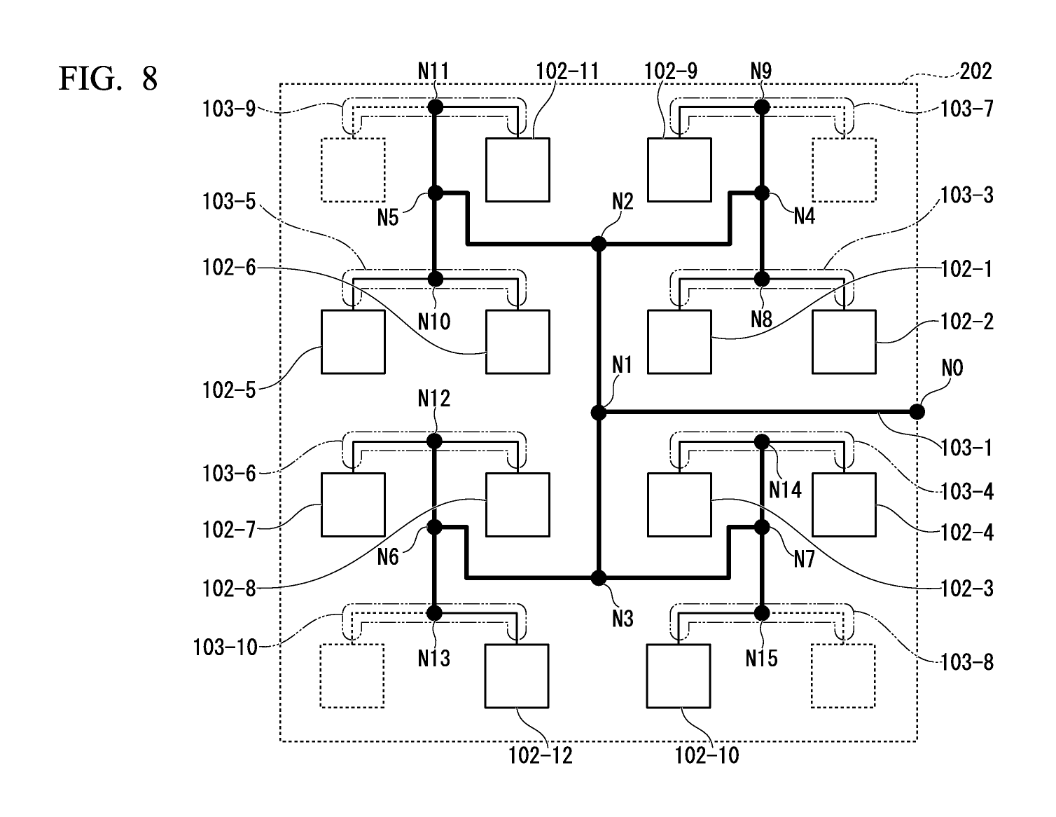

FIG. 8 illustrates an array of radiating elements and a feeder path system connecting the radiating elements in the foregoing embodiments. In the square region 202, there is provided an array of pairs of radiating elements 102-1 through 102-12 and a feeder path system 103-1. The feed path system 103-1 includes a main feeder path 103-2, and first to eighth local feeder paths 103-3, 103-4, 103-5, 103-6, 103-7, 103-8, 103-9, and 103-10.

The array of the radiating elements 102-1 and 102-2 is a modified 4×4 array where no radiating elements are disposed at four corners of the square region 202. The array includes four rows and four columns. The first row includes the ninth and eleventh radiating elements 102-9 and 102-11. The second row includes the first, second, fifth and sixth radiating elements 102-1, 102-2, 102-5, and 102-6. The second row is adjacent to the first row. The third row includes the third, fourth, seventh and eighth radiating elements 102-3, 102-4, 102-7, and 102-8. The third row is adjacent to the second row. The fourth row includes the tenth and eleventh radiating elements 102-10 and 102-11. The fourth row is adjacent to the third row. The first column includes the second and fourth radiating elements 102-2 and 102-4. The second column includes the first, third, ninth and tenth radiating elements 102-1, 102-3, 102-9 and 102-10. The second column is adjacent to the first column. The third column includes the sixth, eighth, eleventh and twelfth radiating elements 102-6, 102-8, 102-11 and 102-12. The third column is adjacent to the second column. The fourth column includes the fifth and seventh radiating elements 102-5 and 102-7. The fourth column is adjacent to the third column.

Each of the radiating elements 102-1 through 102-12 has the same length of the feeder path system 103-1 to a node N0 to which a wireless communicator 105 is connected. For example, the feeder path system 103-1 connects the radiating elements 102-1 through 102-12 to each other. The feeder path system 103-1 extends among the radiating elements 102-1 through 102-12 so that the path length of the feeder path system 103-1 between any one of the radiating elements 102-1 through 102-12 and the node N0 is the same as the path length of the feeder path system 103-1 between any other one of the radiating elements 102-1 through 102-12 and the node N0.

The first local feeder path 103-3 connects a first pair of radiating elements 102-1 and 102-2. The first local feeder path 103-3 is connected to the main feeder path 103-2 at a node N8. The second local feeder path 103-4 connects a second pair of radiating elements 102-3 and 102-4. The second local feeder path 103-4 is connected to the main feeder path 103-2 at a node N14. The third local feeder path 103-5 connects a third pair of radiating elements 102-5 and 102-6. The third local feeder path 103-5 is connected to the main feeder path 103-2 at a node N10. The fourth local feeder path 103-6 connects a fourth pair of radiating elements 102-7 and 102-8. The fourth local feeder path 103-6 is connected to the main feeder path 103-2 at a node N12. The fifth local feeder path 103-7 is connected to a radiating element 102-9 free of any pair of other radiating element. The fifth local feeder path 103-7 is connected to the main feeder path 103-2 at a node N9. The sixth local feeder path 103-8 is connected to a radiating element 102-10 free of any pair of other radiating element. The sixth local feeder path 103-8 is connected to the main feeder path 103-2 at a node N15. The seventh local feeder path 103-11 is connected to a radiating element 102-11 free of any pair of other radiating element. The seventh local feeder path 103-11 is connected to the main feeder path 103-2 at a node N11. The eighth local feeder path 103-10 is connected to a radiating element 102-12 free of any pair of other radiating element. The eighth local feeder path 103-10 is connected to the main feeder path 103-2 at a node N13. The main feeder path 103-2 extends through nodes N0, N1, N2, N3, N4, N5, N6, N7, N8, N9, N10, N11, N12, N13, N14, and N15. The main feeder path 103-2 is connected to the first local feeder path 103-3 at the node N8. The main feeder path 103-2 is connected to the second local feeder path 103-4 at the node N14. The main feeder path 103-2 is connected to the third local feeder path 103-5 at the node N10. The main feeder path 103-2 is connected to the fourth local feeder path 103-6 at the node N13. The main feeder path 103-2 is connected to the fifth local feeder path 103-7 at the node N9. The main feeder path 103-2 is connected to the sixth local feeder path 103-8 at the node N15. The main feeder path 103-2 is connected to the seventh local feeder path 103-9 at the node N11. The main feeder path 103-2 is connected to the eighth local feeder path 103-9 at the node N13. The main feeder path 103-2 extends between the node N0 and the node N1. The main feeder path 103-2 extends between the node N1 and the node N2. The main feeder path 103-2 extends between the node N2 and the node N4. The main feeder path 103-2 extends between the node N4 and the node N8. The main feeder path 103-2 extends between the node N4 and the node N9. The main feeder path 103-2 extends between the node N2 and the node N5. The main feeder path 103-2 extends between the node N5 and the node N10. The main feeder path 103-2 extends between the node N10 and the node N11. The main feeder path 103-2 extends between the node N1 and the node N3. The main feeder path 103-2 extends between the node N3 and the node N7. The main feeder path 103-2 extends between the node N7 and the node N 14. The main feeder path 103-2 extends between the node N7 and the node N15. The main feeder path 103-2 extends between the node N3 and the node N6. The main feeder path 103-2 extends between the node N6 and the node N12. The main feeder path 103-2 extends between the node N6 and the node N13. As illustrated in FIG. 8, the main feeder path 103-2 and the local feeder paths 103-3 to 103-10 run so that the path length of the feeder path system 103-1 between any one of the radiating elements 102-1 through 102-12 and the node N0 is the same as the path length of the feeder path system 103-1 between any other one of the radiating elements 102-1 through 102-12 and the node N0.

The fifth, sixth, seventh and eighth local feeder paths 103-7, 103-8, 103-9, and 103-10 are wider than the first, second, third and fourth local feeder paths 103-3, 103-4, 103-5, and 103-6. The fifth, sixth, seventh and eighth local feeder paths 103-7, 103-8, 103-9, and 103-10 are lower in resistance than the first, second, third and fourth local feeder paths 103-3, 103-4, 103-5, and 103-6 due to the difference in the width between them to cause that the first to eighth radiating elements 102-1 through 102-8 are substantially the same in potential as the ninth to twelfth radiating elements 102-9 through 102-12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An array antenna device comprising:
a plurality of radiating elements, disposed in a plurality of regions defined by excluding at least one region of at least one of the four corners of a polygon defined by overall 2^{N}×2^{N} regions, from the 2^{N}×2^{N} regions provided in a two-dimensional matrix arrangement, where N is an arbitrary natural number of 2 or greater; and
a plurality of feeder paths that feed the plurality of radiating elements.

2. The device according to claim 1, wherein the at least one region in each of the four corners is (((2^{N}/4)×(1+2^{N}/4))/2) regions.

3. The device according to claim 1, wherein the at least one region in each of the four corners are regions, at least one of which is included in a triangular shape defined by a vertex of the polygon and parts of the two sides connected to the vertex, and
wherein the polygon is a rectangle, and one of the two sides has ¼ of the length of a long side of the rectangle and the other of the two sides has ¼ of the length of a short side of the rectangle.

4. The device according to claim 1, further comprising:
a resistive load disposed in the at least one region of the at least one of the four corners,
wherein the feeder path is connected to the resistive load.

5. The device according to claim 1, wherein the feeder paths include a first feeder path and a second feeder path, the first feeder path is connected to a first radiating element included in the plurality of radiating elements, the second feeder path is connected to a second radiating element included in the plurality of radiating elements, the second radiating element is closest to the first radiating element among the plurality of radiating elements, the first feeder path is closest to the at least one region of the at least one of the four corners among the feeder paths, and the first feeder path is wider than the second feeder path.

6. The device according to claim 1, further comprising:
a wireless communicator disposed in the at least one region of the at least one of the four corners,
wherein a feeder path included in the plurality of feeder paths is connected to the wireless communicator.

7. An array antenna device comprising:
a plurality of radiating elements, disposed in a two dimensional array of regions, the two dimensional array being in a polygonal region having a plurality of corners, the two dimensional array having an outer boundary, the outer boundary being in contact with the outer line of the polygonal region, except for at least one of the plurality of corners; and
a plurality of feeder paths that feed the plurality of radiating elements.

8. The device according to claim 7, wherein the polygonal region is a squire region, the two dimensional array is a modified 2^{N}×2^{N} array, where N is 2 or more natural number,
wherein the modified 2^{N}×2^{N} array is obtained by excluding at least one radiating element which is closest to one of the four corners of the squire region, from 2^{N}×2^{N} array of the radiating elements. 9 The device according to claim 8 wherein the at least one region in each of the four corners is (((2^{N}/4)×(1+2^{N}/4))/2) regions.

10. The device according to claim 8 wherein the at least one region in each of the four corners are regions, at least one of which is included in a triangular shape defined by a vertex of the polygon and parts of the two sides connected to the vertex, and
wherein the polygon is a rectangle, and one of the two sides has ¼ of the length of a long side of the rectangle and the other of the two sides has ¼ of the length of a short side of the rectangle.

11. The device according to claim 8 further comprising:
a resistive load disposed in the at least one region of the at least one of the four corners,
wherein the feeder path is connected to the resistive load.

12. The device according to claim 8 wherein the feeder paths include a first feeder path and a second feeder path, the first feeder path is connected to a first radiating element included in the plurality of radiating elements, the second feeder path is connected to a second radiating element included in the plurality of radiating elements, the second radiating element is closest to the first radiating element among the plurality of radiating elements, the first feeder path is closest to the at least one region of the at least one of the four corners among the feeder paths, and the first feeder path is wider than the second feeder path.

13. The device according to claim 8, further comprising:
a wireless communicator disposed in the at least one region of the at least one of the four corners,
wherein a feeder path included in the plurality of feeder paths is connected to the wireless communicator.

14. An array antenna device comprising:
a plurality of pairs of first and second radiating elements,
a feeder path system comprising a main feeder path and a plurality of local feeder paths, the main feeder path being connected to the plurality of local feeder paths; each of the plurality of local feeder paths connecting the first and second radiating element in a pair; and
a third radiating element connected to the feeder path system.

15. The device according to claim 14, wherein the third radiating element is closest to at least one of the four corners of a polygonal region in which the plurality of pairs of first and second radiating elements, the feeder path system and the third radiating element are arrayed.

16. The device according to claim 14, wherein the first, second and third radiating elements have substantially the same feed-path-length of the feeder path system each other.

17. The device according to claim 15, wherein the first, second and third radiating elements have substantially the same feed-path-length of the feeder path system each other.
